(19) United States
(12) Patent Application Publication
(10) Pub. No.: US 2004/0146726 A1
(43) Pub. Date: Jul. 29, 2004

(54) Sheeny ink jet printing material

(76) Inventors: Ulrich Heckes, Odenthal (DE); Andre Becker, Norvenich (DE); Kirsten Barth, Koln (DE); Hans-Joachim Zorn, Bergisch Gladbach (DE); Olaf Friederichs, Burscheld (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/471,689

(22) PCT Filed: Mar. 9, 2002
(86) PCT No.: PCT/EP02/02633

(30) Foreign Application Priority Data
Mar. 13, 2001 (DE) 101 12 327.2

(51) Int. Cl. B32B 9/02

(52) U.S. Cl. 428/478.8; 428/500; 428/384

(57) ABSTRACT

The present invention relates to a process for the production of an inkjet recording material, comprising:

a) application of an aqueous coating slip comprising a pigment and a binder to at least one surface of a substrate for the formation of at least one ink acceptance coating,

b) application of an aqueous coating slip comprising cationic inorganic particles, a binder and a release agent to the ink acceptance coating(s) for the formation of a surface coating,

c) partial drying of the recording material to a total moisture content of 14 to less than 20% by weight of water, based on the total weight of the recording material, and

d) bringing of the partially dried recording material into contact with a heated metal cylinder without remoistening of the coating.

An inkjet recording material comprising a substrate and, at least on one side of the substrate, an ink acceptance coating which contains a pigment and a binder, and a surface coating thereon, the surface coating containing cationic inorganic particles, a binder and a release agent and the surface coating having a gloss value in the range from 5 to 35, measured according to DIN 54502 R′ (75°) (measuring angle 75°), and a surface smoothness, according to the Parker-Print-Surf method (PPS) according to DIN-ISO 8791-4, of less than 2.5 μm, is obtainable thereby.

The present invention relates to a silk gloss ink recording material and a process for its preparation and the use of the inkjet recording material according to the invention for inkjet printing and a printed inkjet recording material.

Owing to the numerous good properties, such as the possibility of printing at high speed, the low noise level during the printing process, the large variety of recorded patterns, the simplicity in multicolor printing, the high quality of the printed image, which can even compete with photographic processes, and the like, inkjet printing has assumed an important position in various areas in the past years. Accordingly, considerable efforts have been made in the past years to provide recording materials for inkjet printing which have improved properties. This is reflected in a virtually unpredictable quantity of publications on inkjet recording material in the technical and patent literature. Some important properties of inkjet recording materials are to be summarized below:

1. High ink acceptance capacity

2. Rapid drying of the applied inkjet image

3. High optical density of the applied ink drops

4. Clear delimitation of the applied inkjet drops

5. Uniformity of the color strength and color density of the applied inkjet print

6. No bleeding of the applied inkjet image

7. Good water resistance and moisture resistance and lightfastness of the applied inkjet image and

8. Dimensional stability of the recording material after printing, in particular avoidance of the occurrence of waves or other dimensional changes.

Moreover, depending on the desired use, the inkjet recording material should have certain surface properties which are to be achieved without the abovementioned inkjet recording properties being adversely affected.

Various methods for the production of a certain surface quality have long been known in papermaking. However, it should be ensured that the ink acceptance property is not adversely affected by the surface treatment and that the recording material is produced in such a way that the subsequent surface treatment does not lead to a deterioration in the ink acceptance properties.

The conventional process for surface treatment is, for example, calendering, with the result that the surface is smoothed and the coating is strengthened.

Thus, DE-A 31 51 471 describes a process for the production of an inkjet recording material, in which a plurality of coatings comprising an inorganic pigment and an aqueous binder composition is applied to a substrate and the coating slip is then dried. According to the teaching of DE-A 31 51 471, it is preferable to subject the recording material thus produced and dried to a further surface treatment either in a friction calender or a supercalender. In the case of the supercalender, the recording material is exposed to a relatively high pressure of 200 N/mm and a temperature of about 70° C., whereas in the friction calender the pressure is 90 N/mm and the temperature about 150° C. However, DE-A 31 51 471 contains no information at all about the gloss or the surface smoothness of the inkjet recording material thus produced.

U.S. Pat. No. 4,770,934 relates to an inkjet recording material in which an ink recording coating comprising a pigment, such as, for example, a synthetic silica having a specific surface area of at least 100 m²/g, and a binder are applied and this surface coating is then formed in a cast coating process. Here, two different cast coating processes can [lacuna], namely the direct method (wet process) in which the moist slip is dried under pressure by contact with a heated polished metal cylinder, in particular having a chromium surface, directly after application of the coating slip. Alternatively, it is possible to use the indirect method (rewet process), in which the coating is first dried and the already dried slip coating is then moistened again before being brought into contact with the hot polished metal cylinder and pressure. Both procedures generally lead to a very high surface gloss. Owing to the coating slip compositions used in U.S. Pat. No. 4,770,934, however, only average gloss ranges between 20 and 50% at an angle of view of 75° are achieved here.

EP-A 0 732 219 discloses a two-coat ink recording material. Here, an ink recording coat comprising a pigment and a binder is first applied to a substrate, and a surface coating which has cationic ultrafine particles having a particle diameter in the range from 1 nm to 500 nm is applied thereon. Here, the surface coating has a gloss of at least 45% at an angle of view of 75°. The recording material described in EP-A 0 732 219 already has these gloss values without particular surface treatment. However, the gloss can also be improved by a cast coating process. Here, the abovementioned direct and indirect methods and the gel method are mentioned. In the gel method, the wet coating is gelled by passing the coated substrate through a coagulation or gelling bath and is then brought into contact with the heated cylinder. Although the ink recording material described in EP-A 0 732 219 has outstanding ink recording properties, it is suitable only for applications in which a high gloss is desired, owing to the inherent high gloss, even when no cast coating method is used.

DE-A 197 44 724 discloses a special cast coating method in which the surfaces of the chromium cylinder with which the moistened recording material is brought into contact under pressure to dry the coating slip is modified, for example by sand blasting. Here, the smoothness of the paper is reduced by reproducing the surface structure of the cylinder which has certain indentations on the surface of the paper. The gloss is likewise reduced as a result.

EP 0 879 709 B1 describes a further cast coating method for the production of a glossy inkjet recording sheet. In order to achieve a glossy surface, it is necessary to use very fine silica particles. It is essential for the coating, after application to the substrate sheet and before drying, to have a very high water content at the surface of the metal cylinder, which surface is polished to a high gloss. If the water content of the coating falls below a critical value, that surface of the metal cylinder which is polished to a high gloss cannot be transferred to the inkjet recording material. This results in surface defects which are inhomogeneously distributed over the entire paper and which result in inhomogeneous low gloss and smoothness values.

DE-A 2 310 891 describes a further process for the surface treatment of a paper. This publication deals with the problem of producing very smooth high-gloss coatings which are comparable with those which are known from the cast coating process described above. For this purpose, an aqueous composition of a binder which is substantially free of pigments is applied for the formation of a surface coating. Thereafter, the moist coating is passed through a heating zone and brought to a temperature which is above the film formation temperature of the binder, so that a polymer film is formed. After the film formation, the substrate is then brought into contact with a heated polished roll. Although no gloss values are stated, it is to be assumed that here too a very high gloss in the range above 45% at an angle of view of 75° is achieved, in particular since it is intended to reproduce the gloss values of cast coating processes, especially since substantially no pigments are present in the surface coating. Moreover, DE-A 2 310 891 relates to the application of a protective plastics coating to already printed substrates. This means that the plastics coating should have no porosity and is therefore completely unsuitable for inkjet printing.

It is therefore an object of the present invention to provide an ink recording material which has outstanding ink acceptance properties and which can also be used for applications in which high gloss is undesired and which, in spite of average gloss values, has a low surface roughness.

A further object of the present invention is to provide a process by means of which an ink recording material meeting the abovementioned requirements can be produced.

This object is achieved by a process for the production of an inkjet recording material, comprising:

a) application of an aqueous coating slip comprising a pigment and a binder to at least one surface of a substrate for the formation of at least one ink acceptance coating,

b) application of an aqueous coating slip comprising cationic inorganic particles, a binder and a release agent to the ink acceptance coating(s) for the formation of a surface coating,

c) partial drying of the recording material and

d) bringing of the partially dried recording material into contact with a heated metal cylinder without remoistening of the coating.

This gives an ink recording material comprising a substrate, which [lacuna], at least on one side of the substrate, an ink acceptance coating which contains a pigment and a binder, and a surface coating thereon, the surface coating containing cationic inorganic particles, a binder and a release agent and the surface coating having a gloss value in the range from 5 to 35, measured according to DIN 54502 R′ (75°) (measuring angle 75°), and a surface smoothness, according to the Parker-Print-Surf method (PPS) according to DIN-ISO 8791-4, of less than 2.5 μm.

For the present invention, it is essential that no cast coating process in the classical sense is used. This means that the substrate coated with the coating slip is not brought directly into contact in the moist state with a heated metal cylinder, nor is the substrate coated with the coating slip dried and then remoistened before it is brought into contact with the metal cylinder. Furthermore, no gel method in which the moist coating is coagulated or gelled before being brought into contact with the metal cylinder is carried out.

The success of the process according to the invention was surprising particularly because a person skilled in the art would expect that the coating would not be uniformly formed on partial drying without subsequent remoistening of the coating but would become detached on contact with the heated roll and would remain adhering to the roll. This would inevitably lead to a breakdown of the production process as well as to a completely unacceptable paper quality. Those skilled in the art have assumed to date that, on drying, remoistening of the coating is necessary in every case in order to ensure uniform formation of the coating on contact with the metal cylinder. For this purpose, in the known “rewet process”, an aqueous remoistening agent which also contains in particular a release agent in order to prevent adhesion of the coated substrate web to the metal cylinder during the shaping and drying process is added in the slot between pressure roll and metal cylinder.

Furthermore, it was surprisingly found that, by means of the process of the present invention, substantially lower gloss values in comparison with the classical cast coating process are achieved without the gloss of the recording material being substantially reduced thereby.

A further process engineering advantage of the present invention is that the process can be carried out on existing cast coating units, and the reduced gloss is produced by the procedure according to the invention without, for example, the polished metal cylinder having to be replaced by a surface-modified metal cylinder, as in the teaching according to DE-A-197 55 724.

However, the decisive advantage of the process according to the invention is that a silk mat ink recording material having outstanding ink acceptance properties is provided hereby.

According to a preferred embodiment, the partial drying of the recording material in step c) of the process according to the invention is carried out in such a way that the recording material is dried [lacuna] a residual moisture content of 14 to less than 20% by weight, preferably 16 to less than 20% by weight and particularly preferably 16 to 18% by weight of water, based on the total weight of the recording material. This can be effected, for example, by hot-air drying at 30° C. to 80° C., preferably at 40° C. to 60° C., for 3 to 60 seconds, preferably 10 to 30 seconds. Alternatively, infrared drying with comparable drying power can also be used.

It is furthermore preferable if the recording material is pressed against the heated cylinder by means of a pressure roll with a nip pressure of 400 to 800 N/cm, preferably 500 to 750 N/cm. The surface temperature of the cylinder is preferably 90° C. to 120° C., particularly preferably 100° C. to 115° C.

The metal cylinder may be any cylinder customarily used in the cast coating process, in particular a cylinder having a polished chromium surface.

In the process according to the invention, an aqueous coating slip is applied in a first process step to at least one side of a sheet-like substrate for formation of the ink acceptance coating. The aqueous coating slip for the formation of the ink acceptance coating, and hence the ink acceptance coating itself, contain a pigment and a binder. Examples of pigments which are suitable for the ink acceptance coating include inorganic pigments, such as, for example, silica, alumina, aluminum hydroxide, aluminum silicate, magnesium silicate, magnesium carbonate, talc, clay, hydrotalcide [sic], calcium carbonate, titanium dioxide and zinc oxide, as well as plastics pigments, such as polyethylene, polystyrene and polyacrylate. These pigments can be used either individually or in combination. Pigments selected from silica, alumina, aluminum hydroxide and magnesium carbonate are particularly preferred. The particle size of these pigments may be in the range between 0.1 and 20 μm.

Suitable binders are water-soluble resins, such as, for example, polyvinyl alcohol, starch, cationic starch, casein, gelatin, acrylic resins, urethane resins, sodium alginate, polyvinylpyrrilidone [sic], carboxymethylcellulose and hydroxyethylcellulose. Furthermore, latices acrylic polymers, such as, for example, polymers of acrylic esters or methacrylic esters, and copolymers of these monomers with other monomers, latices of carboxyl-modified conjugated diene copolymers and latices of vinyl copolymers, such as, for example, ethylene/vinyl acetate copolymers, can be used. These binders can be used either individually or in combination. The ratio of binder to pigment in the ink recording coating is preferably 2:1 to 1:10, particularly preferably 1:1 to 1:5.

Within the abovementioned ranges, an optimum balance between strength of the ink recording coating and ink acceptance capacity is obtained.

The aqueous coating slip for the formation of the ink acceptance coating, and hence the ink acceptance coating itself, may also contain additional components, such as, for example, crosslinking agents, such as melamine resins, glyoxal and isocyanates, surface-active agents, antifoams, antioxidants, optical brighteners, UV absorbents, viscosity modifiers for pH adjustment, etc.

The ink acceptance coating can be applied either as a single coating or as a multiple coating, it being possible for the individual coatings to be either identical or different. The ink acceptance coating preferably has a weight per unit area of 5-20 g/m², based on dry weight.

It is preferable to dry the recording material after application of the ink acceptance coating and before application of the surface coating. However, a wet-on-wet application of the surface coating to an ink acceptance coating which has not been dried or has been only partially dried is likewise possible. Moreover, a commercially available substrate which has a primer coat which fulfills the criteria defined above for the ink acceptance coating can also be used as starting material for the application of the surface coating.

The surface coating is likewise applied by means of an aqueous coating slip to the already applied ink acceptance coating.

A substantial feature of the present invention is that the aqueous coating slip for the formation of the surface coating has cationic inorganic particles, a binder and a release agent.

According to a preferred embodiment, the cationic particles for the surface coating are selected from alumina, aluminum hydroxide or silica, the surface of which has been converted into cationic form α-, β-, γ- and δ-alumina can be used as suitable alumina. Suitable aluminum hydroxides are gibbsite, bayerite, nordostrandite, crystalline boehmite, diaspore and pseudoboehmite. Examples of cationic silicas include silicas which are subjected to a surface treatment with a compound which contain [sic] cationic metal oxides or metal atoms, or silicas which are subjected to surface treatment with an organic compound which contain [sic] both amino groups or quaternary ammonium groups and functional groups which react with the silanol groups on the surface with the silica, such as, for example, aminoethoxysilane or aminoalkylglycidil [sic] ether.

It is particularly preferable if the cationic particles have a mean particle diameter in the range from 1 to 1 000 nm, preferably 10 to 500 nm.

A substantial feature of the present invention is that the inkjet recording material has a coating comprising at least two layers, it being necessary for the surface coating to provide the desired surface properties and the combination of surface coating and ink acceptance coating to provide the desired ink acceptance properties. Here, it is particularly important for the ink recording material to have a high ink acceptance capacity as well as a high rate of acceptance. Furthermore, it is important for the colored pigments of the inks preferably to be fixed in the surface or close to the surface in order to provide a high color density and color brilliance. Furthermore, it is important for the liquid and volatile carrier fluid of the ink to be absorbed as rapidly as possible by the ink recording material and to be separated from the ink dyes so that no bleeding takes place and crisp contours are always produced in the printed image. In particular the cationic particles in the surface coating are important for achieving this.

The cationic particles in the surface coating produce sufficient porosity of the surface coating, which permits rapid absorption of the ink. Owing to the cationic character of the particles, the ink dyes, which are frequently anionic, are at least partly fixed directly in the surface coating, while the carrier fluid of the ink is transported rapidly into the ink absorption coating located under the surface coating. It is thus ensured that a substantial part of the ink dyes is fixed in the uppermost coating of the recording material, even if a part of the ink dyes is held in the ink absorption coating underneath. In any case, it is ensured that the ink dyes are fixed close to the surface. Furthermore, the structure, according to the invention, of the ink recording material permits very rapid removal of the fluid carrier of the ink, with the result that very high ink absorption rates and short drying times are achieved.

According to a particular embodiment of the present invention, the cationic particles have a mean particle diameter in the range from 1 to 1 000 nm, preferably 10 to 500 nm. In this particularly preferred embodiment of the present invention, optimum ink recording properties as well as surface properties can be achieved. A particular advantage of these preferred particle sizes is that the transparency of the surface coating can be increased so that the printed inkjet image has outstanding color brilliance.

Suitable binders for the surface coating are the same binders which were described further above in connection with the ink acceptance coating. Polyurethanes constitute a particularly preferred binder.

The ratio of cationic inorganic particles to binder in the surface coating is preferably within a range from 50:1 to 1:2. In addition to the inorganic particles, finely divided organic resins may also be present in the surface coating. This increases the porosity of the surface coating. The particles of the organic resins preferably have a diameter in the range from 0.05 μm to 2 μm. Examples of fine particles of organic resins include latices of acrylic polymers, such as, for example, polymers of acrylic esters or methacrylic esters and copolymers of these monomers with other monomers, latices of carboxyl-modified conjugated diene polymers, latices of vinyl copolymers, such as, for example, ethylene/vinyl acetate copolymers, finely divided polyvinyl chloride, finely divided polyethylene, finely divided copolymers of vinylpyrrolidone and styrene and finely divided copolymers of vinyl alcohol and styrene.

A further substantial component of the surface coating is a release agent for ensuring that, when the partially dried recording material is brought into contact with the heated metal cylinder when carrying out the process according to the invention, the coating is formed uniformly and completely without the coating becoming detached and/or adhering to the metal cylinder. Suitable release agents are oleic acid, rapeseed oil, metal stearates, ammonium stearates, polyethylenes, ethoxylated polyethylenes, waxes, metal salts and ammonium salts of aliphatic acids, ketene dimers, surface-active agents based on fatty acids, sulfonated and sulfated oils, fatty acid triglycerides and fatty acid amides, oleic acid and rapeseed oil being particularly preferred. The release agents can be used alone or in combination. The total amount of release agent in the aqueous coating slip for formation of the surface coating is preferably 1-10% by weight, based on the total mass of the solids in the coating slip.

According to a particularly preferred embodiment, either the aqueous coating slip for the formation of the ink acceptance coating or the aqueous coating slip for the formation of the surface coating or both coating slips contains or contain a cationic compound which is not a pigment. It is particularly advantageous if at least the surface coating contains such a cationic compound in order to improve the fixing of the generally anionic colored pigments of the ink in the surface coating and hence to improve the wet strength of the inkjet print.

The following are suitable as cationic compounds: polyallylamine and the quaternary ammonium salts thereof, polyamine sulfone and the quaternary ammonium salts thereof, polyvinylamine and the quaternary ammonium salts thereof, chitosan and the acetates thereof, polymers of monomers selected from the group consisting of dimethylaminoethyl (meth)acrylate, diethylaminoethyl (meth)acrylate, methylethylaminoethyl (meth)acrylate, dimethylaminostyrene, diethylaminostyrene, copolymers of vinylpyrrolidone with a quaternary salt of an aminoalkyl (meth)acrylate and a copolymer of (meth)acrylamide with a quaternary salt of aminomethyl(meth)acrylamide.

In order to ensure the cationic character of the coating slip, particularly in the presence of a cationic compound, it is advantageous to adjust the pH of the coating slip in the acidic range. The pH is preferably in the range from 2.5 to 5.0.

Inter alia, paper can be used as a substrate. It is preferable if the substrate itself is porous, i.e. has an absorptivity for liquids which provides the desired dimensional stability for the recording material and has sufficiently good adhesion to the acceptance coating. Paper is therefore particularly preferred as the substrate. The weight per unit area of the paper substrate is preferably from 40 to 300 g/m².

The ink recording material according to the invention which can be produced by the process according to the invention has a surface which [lacuna] a gloss value in the range from 5% to 35%, measured according to DIN 54502 R′ (75°) (measuring angle 75°), and a surface smoothness according to the Parker-Print-Surf method (PPS) according to DIN ISO 8791-4, of less than 2.5 μm on [sic]. According to a preferred embodiment, the gloss value is 5 to less than 30%, in particular 10% to less than 30%, very particularly preferably 12% to 25%, and the surface smoothness is less than 2.2 μm. Thus, a silk matt ink recording material having outstanding ink acceptance properties and high gloss is provided. A particular advantage of the ink recording material according to the invention is the extremely short drying time of the applied inkjet printed image, which is close to zero.

The present invention is now explained in more detail with reference to an example.

### EXAMPLE

On a prefabricated base paper which consists of a body paper having a weight per unit area of 150 g/m² and is provided with a coating which contains silica, polyvinyl alcohol and polydiallyldimethylammonium chloride (based on the dry mass) and was applied with a weight per unit area of 10 g/m², a coating slip according to the composition stated in table 1 and having a solids content of 27% by weight was applied by means of a slip coating roll to the precoated paper web at a web speed of 30 m/min. By means of an air brush, excess coating slip was removed to such an extent that an amount of 11 g/m² of coating (in the dried state) remained on the paper web.

On passing through a hot-air drying stage at 50° C. for 20 seconds, the coated paper web is dried to a residual moisture content of 16% by weight of water, based on the total weight of the paper web, and then immediately passed, without remoistening, into the roll nip which is formed from a resilient pressure roll and a chromium cylinder polished to a high gloss.

The nip pressure of the roll/chromium cylinder pair was 625 N/cm and the temperature of the chromium cylinder surface was 110° C.

The inkjet recording material exhibited outstanding printability in inkjet printing and had a surface gloss of 19% at an angle of view of 75°, measured according to DIN 54502. The surface smoothness according to the Parker-Print-Surf method, measured according to DIN ISO 8791-4, was 1.95 μm.

TABLE 1

| | Percentages, |
|---|---|
| | based on dry |
| Raw material | substances |
| Formic acid | 0.7 |
| Cationic substance¹ | 0.7 |
| Antifoam² | 0.2 |
| Boehmite³ | 71.5 |
| Glycerol | 1.7 |
| Polyurethane⁴ | 17.8 |
| Crosslinking agent⁵ | 1.7 |
| Oleic acid | 5.0 |
| Rapeseed oil | 0.7 |

¹= Polydiallyldimethylammonium chloride from INDULOR Chemie
²= Antifoam FG 116 from HARCORS Chemicals
³= Disperal 140 HT from CONDEA Chemie
⁴= Neorez SB-80-SE from AVECIA
⁵= Ucarlink XL-29 SE from UNION CARBIDE
pH = 4.0

1. An inkjet recording material comprising a substrate and, at least on one side of the substrate, an ink acceptance coating which contains a pigment and a binder, and a surface coating thereon, the surface coating containing cationic inorganic particles, a binder and a release agent and the surface coating having a gloss value in the range from 5 to 35, measured according to DIN 54502 R′ (75°) (measuring angle 75°), and a surface smoothness, according to the Parker-Print-Surf method (PPS) according to DIN-ISO 8791-4, of less than 2.5 μm.

2. The recording material as claimed in claim 1, characterized in that either the surface coating or the ink acceptance coating or both coatings contains or contain a cationic compound which is not a pigment.

3. The recording material as claimed in claim 2, characterized in that the cationic compound is selected from polyallylamine and the quaternary salts thereof, polyamine sulfone and the quaternary salts thereof, polyvinylamine and the quaternary salts thereof, chitosan and the acetates thereof, polymers of monomers selected from the group consisting of dimethylaminoethyl (meth)acrylate, diethylaminoethyl (meth)acrylate, methylethylaminoethyl (meth)acrylate, dimethylaminostyrene, diethylaminostyrene, copolymers of vinylpyrrolidone with a quaternary salt of an aminoalkyl (meth)acrylate and a copolymer of (meth)acrylamide with a quaternary salt of aminomethyl (meth)acrylamide.

4. The recording material as claimed in any of the preceding claims, characterized in that the cationic particles are selected from alumina, aluminum hydroxide or silica, the surface of which has been converted into cationic form.

5. The recording material as claimed in any of the preceding claims, characterized in that the cationic particles have a mean particle diameter in the range from 1-1 000 nm, preferably 10-500 nm.

6. The recording material as claimed in any of the preceding claims, characterized in that the surface coating additionally contains organic pigments obtained from a thermoplastic resin.

7. The recording material as claimed in any of the preceding claims, characterized in that the gloss value is 10-30%, particularly preferably 12-25%.

8. The recording material as claimed in any of the preceding claims, characterized in that the release agent is selected from oleic acid, rapeseed oil, metal stearates, ammonium stearates, polyethylenes, ethoxylated polyethylenes, waxes, metal salts and ammonium salts of aliphatic acids, ketene dimers, surface-active agents based on fatty acids, sulfonated and sulfated oils, fatty acid triglycerides, fatty acid amides and combinations thereof.

9. The recording material as claimed in any of the preceding claims, characterized in that the pigment in the ink acceptance coating is selected from silica, alumina, aluminum hydroxide and basic magnesium carbonate.

10. The recording material as claimed in any of the preceding claims, characterized in that the substrate is paper.

11. The recording material as claimed in any of the preceding claims, characterized in that the weight per unit area of the ink acceptance coating is 5-20 g/mm² and the weight per unit area of the surface coating is 5-20 g/mm², based in each case on the dry weight.

12. A process for the production of an inkjet recording material, comprising:
a) application of an aqueous coating slip comprising a pigment and a binder to at least one surface of a substrate for the formation of at least one ink acceptance coating,
b) application of an aqueous coating slip comprising cationic inorganic particles, a binder and a release agent to the ink acceptance coating(s) for the formation of a surface coating,
c) partial drying of the recording material to a total moisture content of 14 to less than 20% by weight of water, based on the total weight of the recording material, and
d) bringing the partially dried recording material into contact with a heated metal cylinder without remoistening of the coating.

13. The process as claimed in claim 12, characterized in that the recording material is dried to a moisture content of 16 to less than 20% by weight of water, based on the total weight of the recording material.

14. The process as claimed in either of claims 12 and 13, characterized in that the recording material is pressed against the heated cylinder by means of a pressure roll with a nip pressure of 400-800 N/cm, preferably 500-750 N/cm.

15. The process as claimed in any of claims 12-14, characterized in that the heated cylinder is a polished chromium cylinder.

16. The process as claimed in any of claims 12-15, characterized in that either the aqueous coating slip for the formation of the ink acceptance coating or the aqueous coating slip for the formation of the surface coating or both coating slips contains or contain a cationic compound which is not a pigment.

17. The process as claimed in claim 16, characterized in that the cationic compound is selected from polyallylamine and the quaternary ammonium salts thereof, polyamine sulfone and the quaternary ammonium salts thereof, polyvinylamine and the quaternary ammonium salts thereof, chitosan and the acetates thereof, polymers of monomers selected from the group consisting of dimethylaminoethyl (meth)acrylate, diethylaminoethyl (meth)acrylate, methylethylaminoethyl (meth)acrylate, dimethylaminostyrene, diethylaminostyrene, copolymers of vinylpyrrolidone with a quaternary salt of an aminoalkyl (meth)acrylate and a copolymer of (meth)acrylamide with a quaternary salt of aminomethyl (meth)acrylamide.

18. The process as claimed in any of claims 12-7 [sic], characterized in that the cationic particles are selected from alumina, aluminum hydroxide or silica, the surface of which has been converted into cationic form.

19. The process as claimed in any of claims 12-18, characterized in that the cationic particles have a mean particle diameter in the range from 1-1 000 nm, preferably 10-500 nm.

20. The process as claimed in any of claims 12-19, characterized in that the aqueous coating slip for the formation of the surface coating additionally contains organic pigments obtained from a thermoplastic resin.

21. The process as claimed in any of claims 12-20, characterized in that the release agent is selected from oleic acid, rapeseed oil, metal stearates, ammonium stearates, polyethylenes, ethoxylated polyethylenes, waxes, metal salts and ammonium salts of aliphatic acids, ketene dimers, surface-active agents based on fatty acids, sulfonated and sulfated oils, fatty acid triglycerides, fatty acid amides and combinations thereof.

22. The process as claimed in any of claims 12-21, characterized in that the pigment in the aqueous coating slip for the formation of the ink acceptance coating is selected from silica, alumina, aluminum hydroxide and magnesium carbonate.

23. The process as claimed in any of claims 12-22, characterized in that the substrate is paper.

24. The process as claimed in any of claims 12-23, characterized in that the aqueous coating slip for the formation of the ink acceptance coating is applied in an amount to give a weight per unit area of the ink acceptance coating in the dry state of 5-20 g/mm² and the aqueous coating slip for the formation of the surface coating is applied in an amount to give a weight per unit area of the surface coating in the dried state of 5-20 g/mm².

25. The process as claimed in any of claims 12-24, characterized in that the ink recording coating is dried before application of the surface coating.

26. An inkjet recording material obtainable by a process as claimed in any of claims 12-25.

27. The use of the inkjet recording material as claimed in any of claims 1-11 and 26 for printing on by means of an inkjet printer.

28. The inkjet recording material as claimed in any of claims 1-11 and 26, which has a printed image produced by means of an inkjet printer.
